(19) United States
(12) Patent Application Publication
(10) Pub. No.: US 2012/0000846 A1
(43) Pub. Date: Jan. 5, 2012

(54) POLYMER COATED HYDROLYZED MEMBRANE

(76) Inventor: John R. Herron, Corvallis, OR (US)

(21) Appl. No.: 13/100,283

(22) Filed: May 3, 2011

Related U.S. Application Data
(60) Provisional application No. 61/330,559, filed on May 3, 2010.

(51) Int. Cl. B01D 71/28; B05D 5/00; B01D 71/06; B01D 71/14

(52) U.S. Cl. 210/500.29; 210/500.21; 210/500.34; 427/244

(57) ABSTRACT

A method of forming a polymer coated hydrolyzed membrane includes forming a membrane from a first hydrophilic polymer by immersion precipitation, coating the membrane with a thin layer of a second hydrophilic polymer more pH tolerant than the first hydrophilic polymer to form a dense rejection layer, and exposing the coated membrane to a high pH solution thereby forming a hydrolyzed ultrafiltration membrane. A polymer coated hydrolyzed membrane includes a porous membrane formed from a first hydrophilic polymer by immersion precipitation and from hydrolysis, and a dense rejection layer applied to the membrane and formed from a second hydrophilic polymer more pH tolerant than the first hydrophilic polymer.

### CROSS-REFERENCE TO RELATED APPLICATION

This application claims the benefit of the pending provisional application entitled “POLYMER COATED HYDROLYZED MEMBRANE”, Ser. No. 61/330,559, filed May 3, 2010, the entire disclosure of which is hereby incorporated herein by reference.

### BACKGROUND

1. Technical Field

This document relates to a polymer coated hydrolyzed membrane for forward osmosis (FO) and pressure retarded osmosis (PRO) membrane processes and applications, for example.

2. Background

The development of highly selective semi-permeable membranes has been primarily focused on reverse osmosis (RO). High performing RO membranes have a very thin, dense, polymeric layer which is supported by a mechanically-strong porous membrane. The structure of the support membrane has little effect on the flux and selectivity of the membrane.

Recently, the FO has received interest as well. FO membranes have similar species selectivity as RO membranes, but in FO the characteristics of the porous support layer (such as morphology and hydrophilicity) have a large effect on membrane performance.

Currently the only commercially available FO membrane is manufactured by Hydration, Technology Innovations, LLC of Albany, Oreg. (HTI). This is a cellulose triacetate (CTA) membrane with an embedded support screen cast using the immersion precipitation process. This membrane has a dense rejection layer (10-20 micron) far thicker than those common on composite RO membranes (0.2 micron). However the HTI membrane far outperforms composite RO membranes in FO tests due to the openness and hydrophilicity of its porous support layer.

### SUMMARY

Aspects of this document relate to a polymer coated hydrolyzed membrane that couples the high mass transfer of a support layer (e.g., CTA) with a thin dense rejection layer to provided superior FO performance and/or couple a hydrophilic support layer and a very thin rejection layer to raise membrane flux and improve the process economics of PRO for example. These aspects may include, and implementations may include, one or more or all of the components and steps set forth in the appended CLAIMS, which are hereby incorporated by reference.

In one aspect, a method of forming a polymer coated hydrolyzed membrane is disclosed and includes forming a membrane from a first hydrophilic polymer by immersion precipitation, coating the membrane with a thin layer of a second hydrophilic polymer more pH tolerant than the first hydrophilic polymer to form a dense rejection layer, and exposing the coated membrane to a high pH solution thereby forming a hydrolyzed ultrafiltration membrane.

Particular implementations may include one or more or all of the following.

Forming a membrane from a first hydrophilic polymer may include forming an asymmetric membrane by immersion precipitation comprising a solid skin layer and a porous support layer.

Forming an asymmetric membrane by immersion precipitation may include forming the solid skin layer including a thickness of about 5 to about 15 microns and the porous support layer including a thickness of about 20 to about 150 microns.

Forming an asymmetric membrane by immersion precipitation may include forming the solid skin layer including a density of polymer of about 50% or greater polymer by volume and the porous support layer including a density of polymer from about 15% to about 30% polymer by volume.

Coating the membrane with a thin layer of a second hydrophilic polymer may include coating the solid skin layer of the asymmetric membrane with a thin layer of a second hydrophilic polymer more pH tolerant than the first hydrophilic polymer to form a dense rejection layer.

Forming an asymmetric membrane by immersion precipitation may include forming an asymetric cellulose membrane from a hydrophilic cellulose ester polymer by immersion precipitation.

Exposing the coated membrane to a high pH solution may include exposing the asymetric cellulose membrane to a high pH solution thereby hydrolyzing a cellulosic portion of the asymetric cellulose membrane to form a hydrolyzed ultrafiltration membrane.

Exposing the coated membrane to a high pH solution may include exposing the coated membrane to a solution with a pH of about 12 or greater thereby forming a hydrolyzed ultrafiltration membrane

Coating the membrane with a thin layer of a second hydrophilic polymer may include coating the membrane with a 1 micron or less thick layer of a second hydrophilic polymer more pH tolerant than the first hydrophilic polymer to form a dense rejection layer.

Coating the membrane with a thin layer of a second hydrophilic polymer may include coating the membrane with a sulfonated polystyrene polyisobutylene block copolymer to form a dense rejection layer.

In another aspect, a polymer coated hydrolyzed membrane is disclosed and may include: a porous membrane formed from a first hydrophilic polymer by immersion precipitation and from hydrolysis, the membrane comprising a skin layer supported by a support layer; and a dense rejection layer applied to the skin layer and formed from a second hydrophilic polymer more pH tolerant than the first hydrophilic polymer.

Particular implementations may include one or more or all of the following.

The membrane may be an asymmetric membrane. The asymmetric membrane may be an asymmetric cellulose membrane formed from a hydrophilic cellulose ester polymer.

The skin layer may have a thickness of about 5 to about 15 microns and the porous support layer may have a thickness of about 20 to about 150 microns.

The skin layer may have a density of polymer of about 50% or greater polymer by volume and the porous support layer may have a density of polymer from about 15% to about 30% polymer by volume.

The dense rejection layer may have a thickness of about 1 micron or less.

The dense rejection layer may be formed from a sulfonated polystyrene polyisobutylene block copolymer.

The foregoing and other aspects, features, and advantages, as well as other benefits discussed elsewhere in this document, will be apparent to those of ordinary skill in the art from the DESCRIPTION, and from the CLAIMS.

### DESCRIPTION

This document features a polymer coated hydrolyzed membrane for forward osmosis (FO) and pressure retarded osmosis (PRO) membrane processes and applications, for example. Polymer coated hydrolyzed membrane implementations couple the high mass transfer of the CTA support layer with a thin dense layer to provided superior FO performance for example. Polymer coated hydrolyzed membrane implementations also couple a hydrophilic support layer and a very thin rejection layer to raise membrane flux and improve the process economics of PRO for example.

There are many features of polymer coated hydrolyzed membrane implementations disclosed herein, of which one, a plurality, or all features or steps may be used in any particular implementation. In the following description, it is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

Notwithstanding, for the exemplary purposes of this disclosure, a process of forming polymer coated hydrolyzed membrane implementations may generally include coating a cellulosic membrane formed with the immersion precipitation process with a very thin hydrophilic dense layer of a more pH tolerant polymer. The membrane may then be exposed to a high pH solution which hydrolyzes the cellulose ester thus making it an ultrafiltration membrane which is even more hydrophilic and permeable than the CTA membrane. The thin coating of the pH resistant polymer then becomes the dense rejection layer.

Immersion Precipitation

The immersion precipitation process is described in U.S. Pat. No. 3,133,132, which is hereby incorporated by reference.

In general, first, a membrane polymeric material (e.g., a hydrophilic polymer (e.g. a cellulose ester such as cellulose acetate, cellulose triacetate, etc.)) is dissolved in water-soluble solvent (non-aqueous) system to form a viscous solution. Appropriate water-soluble solvent systems for cellulosic membranes include, for example, (e.g. ketones (e.g., acetone, methyl ethyl ketone and 1,4-dioxane), ethers, alcohols). Also included/mixed in the solution are pore-forming agents (e.g. organic acids, organic acid salts, mineral salts, amides, and the like, such as malic acid, citric acid, lactic acid, lithium chloride, and the like for example) and strengthening agents (e.g., agents to improve pliability and reduce brittleness, such as methanol, glycerol, ethanol, and the like for example).

Next, a thin layer of the viscous solution is spread evenly on a surface and allowed to air dry for a short time. Then one side of the viscous solution is brought into contact with water. The water contact causes the polymer in solution to become unstable and a layer of dense polymer precipitates on the surface very quickly. This layer acts as an impediment to water penetration further into the solution so the polymer beneath the dense layer precipitates much more slowly and forms a loose, porous matrix. The dense layer is the portion of the membrane which allows the passage of water while blocking other species. The porous layer acts merely as a support for the dense layer. The support layer is needed because on its own a 10 micron thick dense layer, for example, would lack the mechanical strength and cohesion to be of any practical use.

Then, after all the polymer is condensed from the viscous solution the membrane can be washed and heat treated.

Thus, the immersion/precipitation process may form an asymmetric membrane with a solid dense or skin layer as a surface component, having about 5-15 microns in thickness for example. Also formed is a porous or scaffold layer composed of the same polymeric material as the dense layer, wherein the porous or scaffold layer is highly porous and allows diffusion of solids within the porous or scaffold layer. The porous or scaffold layer may have a thickness of 20 to 150 microns for example. The dense or skin layer and the porous or scaffold layer created by the immersion/precipitation process have their porosities controlled by both the casting parameters and by the choices of solvent and ratio of solids of polymeric material to solvent solution. The porous or scaffold layer may have a density of polymer as low as possible, such as from about 15-30% polymer by volume. The top dense or skin layer may have a density of polymer of greater than 50% polymer.

In RO the flux of the membrane is overwhelmingly dependent on the thickness, composition and morphology of the dense or skin layer, so there has been little impetus to optimize the performance of the porous layer. However in FO and PRO, water is drawn through the membrane by a difference in dissolved species concentration across the dense layer. If the higher concentration is on the porous layer side of the dense layer, the water being pulled through the dense layer carries the dissolved species in the porous layer away from the dense layer. For the process to continue, the dissolved species must diffuse back through the porous layer to the dense layer. Likewise, if the higher concentration is on the open side of the dense layer, as water is extracted from the fluids in the porous layer, the concentration of dissolved species in the porous layer will increase. For the process to continue they must diffuse out of the back of the membrane into the feed solution.

Therefore, for the purposes of this disclosure, it is critical that the porous layer be as hydrophilic and open as possible so that it presents as small a resistance to diffusion as possible.

Many additional implementations are possible.

For the exemplary purposes of this disclosure, in one implementation the solution may be extruded onto a surface of a hydrophilic backing material. An air-knife may be used to evaporate some of the solvent to prepare the solution for formation of the dense or skin layer. The backing material with solution extruded on it is then introduced into a coagulation bath (e.g., water bath). The water bath causes the membrane components to coagulate and form the appropriate membrane characteristics (e.g., porosity, hydrophilic nature, asymmetric nature, and the like). In an FO process, water transport occurs through the holes of the mesh backing layer as the mesh backing fibers do not offer significant lateral resistance (that is, the mesh backing does not significantly impede water getting to surface of membrane). The membrane may have an overall thickness from about 10 microns to about 150 microns (excluding the porous backing material) for example. The porous backing material may have a thickness of from about 50 microns to about 500 microns in thickness for example.

For the exemplary purposes of this disclosure, in another implementation the solution may be cast onto a rotating drum and an open fabric is pulled into the solution so that the fabric is embedded into the solution. The solution is then passed under an air knife and into the coagulation bath. The membrane may have an overall thickness of 75 to 150 microns and the support fabric may have a thickness from 50 to 100 microns. The support fabric may also have over 50% open area. The support fabric may be a woven or nonwoven nylon, polyester or polypropylene, and the like for example, or it could be a cellulose ester membrane cast on a hydrophilic support such as cotton or paper.

Further implementations are within the CLAIMS.

Polymer Coating

The dense or skin layer of a cellulosic membrane formed by the immersion precipitation process as described above may be coated with a very thin hydrophilic dense layer of a more pH tolerant polymer. It is this thin coating of the pH resistant polymer which will then become the dense rejection layer.

Applying a thin coating to a dense or skin layer of a cellulosic membrane has been pioneered for gas separation membranes and is described in U.S. Pat. No. 4,230,463, which is hereby incorporated by reference. In this procedure the cellulosic membrane is dried by first replacing the bound water with alcohol, then replacing the alcohol with hexane. The polymer to be coated on the membrane is then dissolved in hexane and applied to the membrane surface after which the hexane is removed by evaporation.

In gas separation membranes a 0.2 micron layer of silicone rubber is commonly used. However, this rubber is not appropriate for FO or PRO because silicone rubber is hydrophobic and in FO or PRO the dense layer must be hydrophilic.

Accordingly, the applied polymer is pH resistant, hydrophilic, and pliable. An example of such a polymer which can be applied by the hexane coating process described above is a sulfonated polystyrene polyisobutylene block copolymer described in U.S. Pat. No. 6,579,984, which is hereby incorporated by reference. This polymer is rubbery, hydrophilic, dense enough to provide RO level separations, and tolerant to pH over 12. Coatings of thicknesses one (1) micron or less (e.g., 0.2 micron) are readily achievable.

Many additional implementations are possible and further implementations are within the CLAIMS.

Membrane Hydrolyzation

Once coated with a very thin hydrophilic dense layer of a more pH tolerant polymer, the membrane may be rewetted with water. The cellulosic portion of the membrane may then be rendered more open by hydrolysis.

In this process some or all of the acetate groups that are esterifies to cellulose are replaced with hydroxyl groups by exposure of the membrane to a solution with a pH of about 12 or greater. After hydrolysis the membrane has a dense rejection layer less than one (1) micron in thickness supported by a very hydrophilic, asymmetric ultrafiltration membrane.

This membrane can be strengthened as needed for PRO by inclusion of cellulose acetate butyrate in the cellulose acetate mixture of the membrane cast by the immersion precipitation process.

Many additional implementations are possible and further implementations are within the CLAIMS.

Specifications, Materials, Manufacture, Assembly

It will be understood that implementations are not limited to the specific components disclosed herein, as virtually any components consistent with the intended operation of a polymer coated hydrolyzed membrane may be utilized. Accordingly, for example, although particular components and so forth, are disclosed, such components may comprise any shape, size, style, type, model, version, class, grade, measurement, concentration, material, weight, quantity, and/or the like consistent with the intended operation of a polymer coated hydrolyzed membrane implementation. Implementations are not limited to uses of any specific components, provided that the components selected are consistent with the intended operation of a polymer coated hydrolyzed membrane implementation.

Accordingly, the components defining any a polymer coated hydrolyzed membrane implementation may be formed of any of many different types of materials or combinations thereof that can readily be formed into shaped objects provided that the components selected are consistent with the intended operation of a polymer coated hydrolyzed membrane implementation. For the exemplary purposes of this disclosure, the membranes implementations may be constructed of a wide variety of materials and have a wide variety of operating characteristics. For example, the membranes may be semi-permeable, meaning that they pass substantially exclusively the components that are desired from the solution of higher concentration to the solution of lower concentration, for example, passing water from a more dilute solution to a more concentrated solution. Any of a wide variety of membrane types may be utilized using the principles disclosed in this document.

As a restatement of or in addition to what has already been described and disclosed above, the FO or PRO membrane may be made from a thin film composite RO membrane. Such membrane composites include, for example, a cellulose ester membrane cast by an immersion precipitation process (which could be cast on a porous support fabric such as woven or nonwoven nylon, polyester or polypropylene, or preferably, a cellulose ester membrane cast on a hydrophilic support such as cotton or paper). The membranes used may be hydrophilic, membranes with salt rejections in the 80% to 95% range when tested as a reverse osmosis membrane (60 psi, 500 PPM NaCl, 10% recovery, 25.degree. C.). The nominal molecular weight cut-off of the membrane may be 100 daltons. The membranes may be made from a hydrophilic membrane material, for example, cellulose acetate, cellulose proprianate, cellulose butyrate, cellulose diacetate, blends of cellulosic materials, polyurethane, polyamides. The membranes may be asymmetric (that is, for example, the membrane may have a thin rejection layer on the order of one (1) or less microns thick and a dense and porous sublayers up to 300 microns thick overall) and may be formed by an immersion precipitation process. The membranes are either unbacked, or have a very open backing that does not impede water reaching the rejection layer, or are hydrophilic and easily wick water to the membrane. Thus, for mechanical strength they may be cast upon a hydrophobic porous sheet backing, wherein the porous sheet is either woven or non-woven but having at least about 30% open area. The woven backing sheet may be a polyester screen having a total thickness of about 65 microns (polyester screen) and total asymmetric membrane is 165 microns in thickness. The asymmetric membrane may be cast by an immersion precipitation process by casting a cellulose material onto a polyester screen. The polyester screen may be 65 microns thick, 55% open area.

Various polymer coated hydrolyzed membrane implementations may be manufactured using conventional procedures as added to and improved upon through the procedures described here.

Use

Implementations of a polymer coated hydrolyzed membrane are particularly useful in FO/water treatment applications. Such applications may include osmotic-driven water purification and filtration, desalination of sea water, purification of contaminated aqueous waste streams, and the like.

However, implementations are not limited to uses relating to FO applications. Rather, any description relating to FO applications is for the exemplary purposes of this disclosure, and implementations may also be used with similar results in a variety of other applications. For example, polymer coated hydrolyzed membrane implementations may also be used for PRO systems. The difference is that PRO generates osmotic pressure to drive a turbine or other energy-generating device. All that would be needed is to switch to feeding fresh water (as opposed to osmotic agent) and the salt water feed can be fed to the outside instead of source water (for water treatment applications).

In places where the description above refers to particular implementations, it should be readily apparent that a number of modifications may be made without departing from the spirit thereof and that these implementations may be alternatively applied. The accompanying CLAIMS are intended to cover such modifications as would fall within the true spirit and scope of the disclosure set forth in this document. The presently disclosed implementations are, therefore, to be considered in all respects as illustrative and not restrictive, the scope of the disclosure being indicated by the appended CLAIMS rather than the foregoing DESCRIPTION. All changes that come within the meaning of and range of equivalency of the CLAIMS are intended to be embraced therein.

1. A method of forming a polymer coated hydrolyzed membrane comprising:
forming a membrane from a first hydrophilic polymer by immersion precipitation;
coating the membrane with a thin layer of a second hydrophilic polymer more pH tolerant than the first hydrophilic polymer to form a dense rejection layer; and
exposing the coated membrane to a high pH solution thereby forming a hydrolyzed ultrafiltration membrane.

2. The method of claim 1, wherein forming a membrane from a first hydrophilic polymer comprises forming an asymmetric membrane by immersion precipitation comprising a solid skin layer and a porous support layer.

3. The method of claim 2, wherein forming an asymmetric membrane by immersion precipitation comprises forming the solid skin layer comprising a thickness of about 5 to about 15 microns and the porous support layer comprising a thickness of about 20 to about 150 microns.

4. The method of claim 2, wherein forming an asymmetric membrane by immersion precipitation comprises forming the solid skin layer comprising a density of polymer of about 50% or greater polymer by volume and the porous support layer comprising a density of polymer from about 15% to about 30% polymer by volume.

5. The method of claim 2, wherein coating the membrane with a thin layer of a second hydrophilic polymer comprises coating the solid skin layer of the asymmetric membrane with a thin layer of a second hydrophilic polymer more pH tolerant than the first hydrophilic polymer to form a dense rejection layer.

6. The method of claim 2, wherein forming an asymmetric membrane by immersion precipitation comprises forming an asymetric cellulose membrane from a hydrophilic cellulose ester polymer by immersion precipitation.

7. The method of claim 6, wherein exposing the coated membrane to a high pH solution comprises exposing the asymetric cellulose membrane to a high pH solution thereby hydrolyzing a cellulosic portion of the asymetric cellulose membrane to form a hydrolyzed ultrafiltration membrane.

8. The method of claim 1, wherein exposing the coated membrane to a high pH solution comprises exposing the coated membrane to a solution with a pH of about 12 or greater thereby forming a hydrolyzed ultrafiltration membrane

9. The method of claim 1, wherein coating the membrane with a thin layer of a second hydrophilic polymer comprises coating the membrane with a 1 micron or less thick layer of a second hydrophilic polymer more pH tolerant than the first hydrophilic polymer to form a dense rejection layer.

10. The method of claim 1, wherein coating the membrane with a thin layer of a second hydrophilic polymer comprises coating the membrane with a sulfonated polystyrene polyisobutylene block copolymer to form a dense rejection layer.

11. A polymer coated hydrolyzed membrane comprising:
a porous membrane formed from a first hydrophilic polymer by immersion precipitation and from hydrolysis, the membrane comprising a skin layer supported by a support layer; and
a dense rejection layer applied to the skin layer and formed from a second hydrophilic polymer more pH tolerant than the first hydrophilic polymer.

12. The membrane of claim 11, wherein the membrane is an asymmetric membrane.

13. The membrane of claim 12, wherein the asymmetric membrane comprises an asymmetric cellulose membrane formed from a hydrophilic cellulose ester polymer.

14. The membrane of claim 12, wherein the skin layer comprises a thickness of about 5 to about 15 microns and the porous support layer comprises a thickness of about 20 to about 150 microns.

15. The membrane of claim 12, wherein the skin layer comprises a density of polymer of about 50% or greater polymer by volume and the porous support layer comprises a density of polymer from about 15% to about 30% polymer by volume.

16. The membrane of claim 11, wherein the dense rejection layer comprises a thickness of about 1 micron or less.

17. The membrane of claim 11, wherein the dense rejection layer is formed from a sulfonated polystyrene polyisobutylene block copolymer.
